(19) United States
(12) Patent Application Publication
(10) Pub. No.: US 2011/0073817 A1
(43) Pub. Date: Mar. 31, 2011

(54) Wheel Ornament Installation Tool

(76) Inventor: David P. Branik, Grosse Ile, MI (US)

(21) Appl. No.: 12/773,294

(22) Filed: May 4, 2010

Related U.S. Application Data
(60) Provisional application No. 61/246,760, filed on Sep. 29, 2009.

(51) Int. Cl. B60B 31/06

(52) U.S. Cl. 254/124; 254/120; 254/129; 254/131

(57) ABSTRACT

A wheel ornament installation tool includes a supporting portion and a rotatable portion rotatably coupled to the supporting portion. The rotatable portion is configured to apply a force against a wheel ornament during rotation of the rotatable portion. The supporting portion is configured to engage a stationary object to support the rotatable portion during application of the force against the wheel ornament.

### CROSS-REFERENCE TO RELATED APPLICATIONS

This application claims the benefit of U.S. Provisional Application Ser. No. 61/246,760 filed on Sep. 29, 2009.

### TECHNICAL FIELD

The present invention relates to tooling for facilitating fabrication of vehicle wheel assemblies and, more particularly, to a tool for facilitating attachment of a wheel ornament to a vehicle wheel.

### BACKGROUND OF THE INVENTION

Wheel ornaments are commonly attached to vehicle wheel rims in order to change the outward appearance of the wheel rims. Retention features are generally formed on either or both of the wheel rim and wheel ornament in order to retain the wheel ornament on the wheel rim during vehicle use. Frequently these retention features are resilient to permit deflection of the features during pressing of the wheel onto the rim. Pressing of the wheel ornament onto the wheel rim produces deflection of the retention features, which then snap back into an undeflected state after the ornament has reached a desired seating position on the wheel rim. Thus, in order to attach the ornament to the wheel, an attachment force must be exerted that is sufficient to overcome the resistance provided by the resiliently deflecting retention features prior to snap back.

The attachment force may be applied by a user using a hammer of other impact-producing mechanism. However, the amount of force required to overcome the retention feature resistance may vary with the design of the wheel ornament and/or rim. In addition, the amount of impact force applied may be difficult to control or to control consistently, especially where the force is applied manually. Application of an excessive attachment force using impact methods may fracture or otherwise damage the wheel ornament.

Thus, it is desirable to provide a means for consistently applying a force sufficient to deflect the retention features prior to snap back while minimizing the risk of impact or other damage to the wheel ornament.

### SUMMARY OF THE INVENTION

In one aspect of the embodiments of the present invention, a wheel ornament installation tool is provided including a supporting portion and a rotatable portion rotatably coupled to the supporting portion. The rotatable portion is configured to apply a force against a wheel ornament during rotation of the rotatable portion, and the supporting portion is configured to engage a stationary object to support the rotatable portion during application of the force against the wheel ornament.

In another aspect of the embodiments of the present invention, a wheel ornament installation tool is provided including a first actuator and a second actuator for applying a force to a wheel ornament. The second actuator is operatively coupled to the first actuator so as to enable vertical positioning of the second actuator by the first actuator.

### BRIEF DESCRIPTION OF THE DRAWINGS

In the drawings illustrating embodiments of the present invention:

FIG. 1 is a plan view of a wheel ornament installation tool in accordance with one embodiment of the present invention.

FIG. 2 is a perspective view the tool shown in FIG. 1 engaged with a vehicle wheel during application of an attachment force to a wheel ornament.

FIG. 3 is another perspective view the tool shown in FIG. 1 engaged with a vehicle wheel during application of an attachment force to a wheel ornament.

FIG. 4 is a perspective view of a wheel ornament installation tool in accordance with another embodiment of the present invention.

FIG. 5 is a perspective view of a wheel ornament installation tool in accordance with yet another embodiment of the present invention.

FIGS. 6a-6c are perspective views of a portion of the wheel ornament installation tool embodiment shown in FIG. 5.

### DETAILED DESCRIPTION

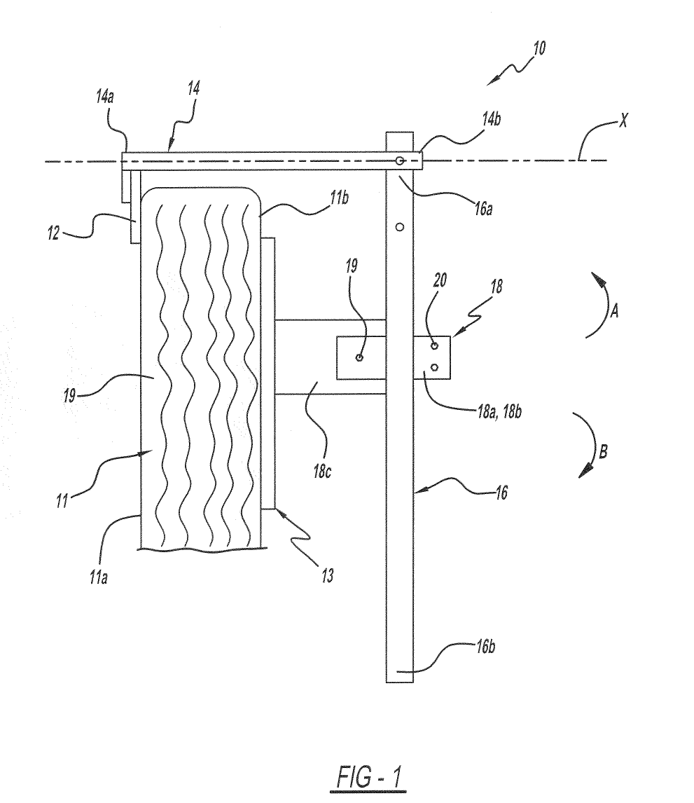

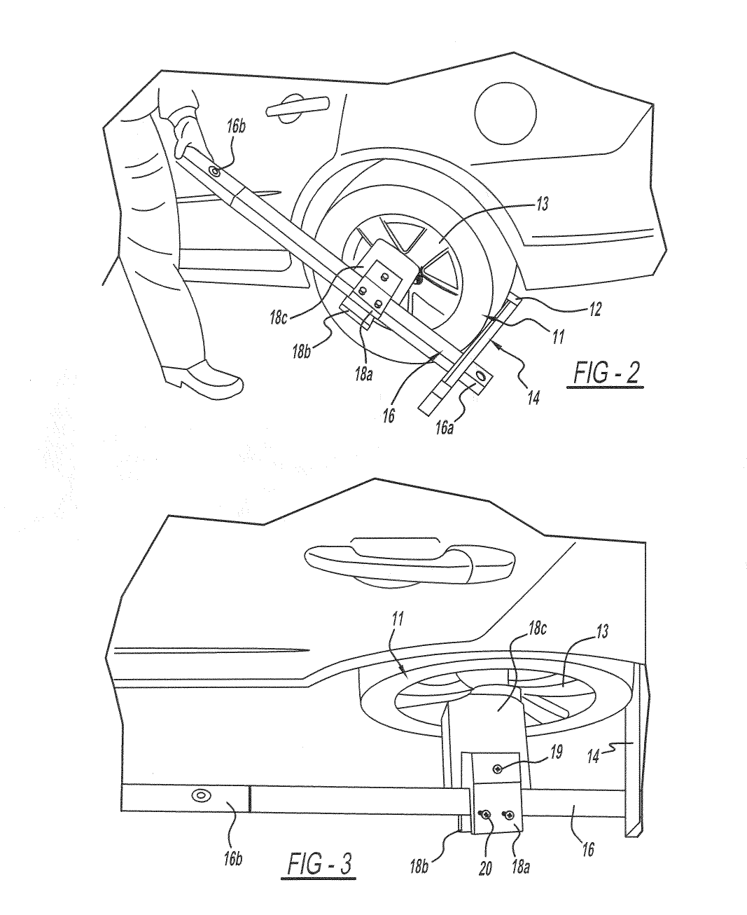

FIGS. 1-3 show a wheel ornament installation tool 10 in accordance with a first embodiment of the present invention. Tool 10 is shown engaged with a vehicle wheel or tire 11 during application of a wheel ornament 13 to the wheel. In the embodiment shown in FIGS. 1-3, tool 10 includes a supporting portion and a rotatable portion rotatably coupled to the supporting portion and configured to apply a force against a wheel ornament during rotation of the rotatable portion.

The supporting portion is configured to engage a stationary object to support the rotatable portion during application of the force against the wheel ornament. In the embodiment shown in FIGS. 1-3, the supporting portion comprises a first portion 12 and a second portion 14 operatively coupled to the first portion. First portion 12 is configured for abutting or engaging a portion of the vehicle during application of the wheel ornament to the wheel or tire.

First portion 12 is operatively coupled to, and extends in a direction away from, a second portion 4. In the embodiment shown in FIGS. 1-3, first portion 12 is configured to engage a first side 11a of wheel or tire 11 during application of the wheel ornament to the wheel rim. However, portion 12 may alternatively be configured to engage another portion of the vehicle (for example, a portion of the vehicle body, chassis, or frame). The first portion may also be configured to engage a stationary object to support the rotatable portion during application of the force against the wheel ornament. As defined herein, the term “stationary object” is understood to designate any object or feature separate from the vehicle, and which is stationary with respect to the vehicle while the wheel ornament installation tool is being employed. This enables the supporting portion of the tool to serve as an anchor or base for the rotatable portion of the tool.

Alternatively, the tool may be configured so that the direction in which first portion 12 extends from second portion 14 is adjustable and securable to permit first portion 12 to abut any conveniently-located feature of the vehicle during application of the wheel ornament. For example, first portion 12 may be rotatable about a longitudinal axis X of second portion 14 and securable in a desired orientation using a thumbscrew or a bolt (not shown) which can be loosened and tightened with a wrench of other tool. First portion 12 may be formed from steel or any other material suitable for the uses of the first portion as described herein. First portion 12 may be coupled to second portion 14 using welds, bolts, or any other suitable attachment method.

Referring again to FIGS. 1-3, second portion 14 has a first end 14a and a second end 14b. Second portion 14 is rotatably coupled to a third portion 16 using, for example, a pin or a suitable hinge-type mechanism. In one embodiment, first portion 12 is coupled to second portion 14 proximate second portion first end 14a. In a particular embodiment, tool 10 is configured so that first portion 12 is adjustably positionable and securable along a length of second portion 14, thereby enabling the tool to be adjusted so as to be usable for attaching wheel ornaments to wheels of widely differing widths. The position of first portion 12 along second portion 14 may be adjusted as desired, then the first portion may be secured in the desired position using a thumbscrew or a bolt (not shown) which can be loosened and tightened with a wrench of other tool.

Alternatively, second portion 14 may be formed from two or more parts configured so as to telescope, enabling the length of the second portion to be adjusted according to the width of a wheel to which the wheel ornament is to be applied. Second portion 14 may be formed from steel or any other material suitable for the uses of the second portion as described herein.

In the embodiment shown in FIGS. 1-3 the rotatable portion includes a third portion 16 rotatably coupled to second portion 14 and a fourth portion 18 operatively coupled to the third portion 16 for applying the force to the wheel ornament during rotation of the third portion. Third portion 16 has a first end 16a and a second end 16b. In the embodiment shown in FIGS. 1-3, second portion 14 is rotatably coupled to third portion 16 proximate first end 16a. However, the second portion may be coupled to the third portion at any suitable location along the length of the third portion. Third portion 16 may be formed from steel or any other material suitable for the uses of the second portion as described herein.

Referring again to FIGS. 1-3, a fourth portion 18 is operatively coupled to third portion 16. In the embodiment shown in FIGS. 1-3, fourth portion 18 includes a pair of opposed brackets 18a, 18b and a bearing portion 18c.

Bearing portion 18c contacts the wheel ornament and forces it onto the wheel. Thus, it is the medium by which the force of a user is transmitted to the wheel ornament. Bearing portion 18c may be configured with retention features suitable for holding the wheel ornament prior to application of the ornament to the wheel. Alternatively, the wheel ornament may be seated on the wheel rim prior to bearing portion 18c engaging the ornament to snap the ornament into place on the wheel. Bearing portion 18c may be formed from steel or any other material suitable for the uses of the bearing portion as described herein. Bearing portion 18c may be fabricated so as to have a surface finish smooth enough to prevent abrasion or other surface damage to the wheel ornament during application of the ornament to the wheel rim. In a particular embodiment, to prevent damage to the surface of the wheel ornament, bearing portion 18c is formed from a material (for example, a polymer material) having the strength and rigidity to transmit the applied assembly force to the wheel ornament without fracturing.

Alternatively, the bearing portion may include a relatively soft pad or cushion for contacting the wheel ornament, and a relatively rigid backing portion interposed between the pad and the third portion 16 through which the wheel ornament attachment force is applied to the cushion. The cushion may be designed to substantially conform to the shape of the portion of the ornament with which it is in contact when a force is applied to the cushion and wheel ornament.

The backing portion may be designed to substantially conform to the same portion of the ornament as fabricated. For example, for a curved or semi-spherical portion of the wheel ornament, the surface of the backing portion in contact with the cushion could have substantially the same curvature. When the attachment force is applied to the ornament through the backing portion and cushion, the contact surface of the cushion conforms to the shape of the ornament and the backing portion, and the relatively rigid backing portion helps ensure that the force is substantially evenly applied through the cushion to the surface of the ornament. This structure would enable substantially uniform application of the attachment force to the ornament, while also preventing surface damage to the ornament.

Brackets 18a and 18b secure bearing portion 18c to third portion 16. In the embodiment shown in FIGS. 1-3, bearing portion 16c is secured to third portion 14 using bolts 19 which attach the bearing portion to the brackets, and bolts 20 which couple the brackets 18a and 18b to third portion 16.

In a particular embodiment, tool 10 is configured so that fourth portion 18 is adjustably positionable and securable along a length of third portion 16, thereby enabling the tool to be adjusted so as to be usable for attaching wheel ornaments to wheels of widely differing radii. Bolts 20 may be loosened so that fourth portion 18 slides along the length of third portion 16. The position of fourth portion 18 along third portion 16 may then be adjusted as desired, after which the fourth portion is secured in the desired position along third portion 16 by tightening bolts 20. Alternatively, the position of the fourth portion along the third portion may be fixed to accommodate a wheel having a specific radius. Third portion 16 may be formed from steel or any other material suitable for the uses of the second portion as described herein.

In another alternative embodiment, the bearing portion 18c is formed as an integral part of with fourth portion 18 rather than as a separate part.

Operation of tool 10 to attach a wheel ornament to a second side 11b of heel 11 now be discussed with reference to FIGS. 1-3

To apply the necessary attachment force, first portion 12 is positioned to abut or engage side 11a of wheel 11 (or another suitable portion of the vehicle). This braces the tool against the vehicle for application of the ornament seating force by a user, in a manner described below. Fourth portion 18 is positioned and secured by a user (if the fourth portion has not been previously secured in the desired position) along third portion 16 such that the bearing portion will engage and apply force to a wheel ornament 13 positioned on the wheel rim when third portion 16 is rotated in the direction indicated by arrow B. Third portion 16 is then rotated about second portion 14 in the direction of arrow A, to enable pre-assembly positioning of the wheel ornament. The wheel ornament is then positioned on the wheel 11 or onto bearing portion 18c. The bearing portion 18a can be configured with wheel ornament retention features suitable for holding the ornament thereon during attachment of the ornament to the wheel.

Next, third portion 16 is rotated by a user in the direction indicated by arrow B to apply the ornament to the wheel rim (or to apply a force to an ornament already positioned on the wheel rim). The user continues to apply force proximate second end 16b of third portion 16 until the resistance of the wheel ornament retention features engaging the wheel rim is overcome and the wheel ornament snaps into place. During this process, first portion 12 braces the tool against wheel 11 (or against another suitable portion of the vehicle).

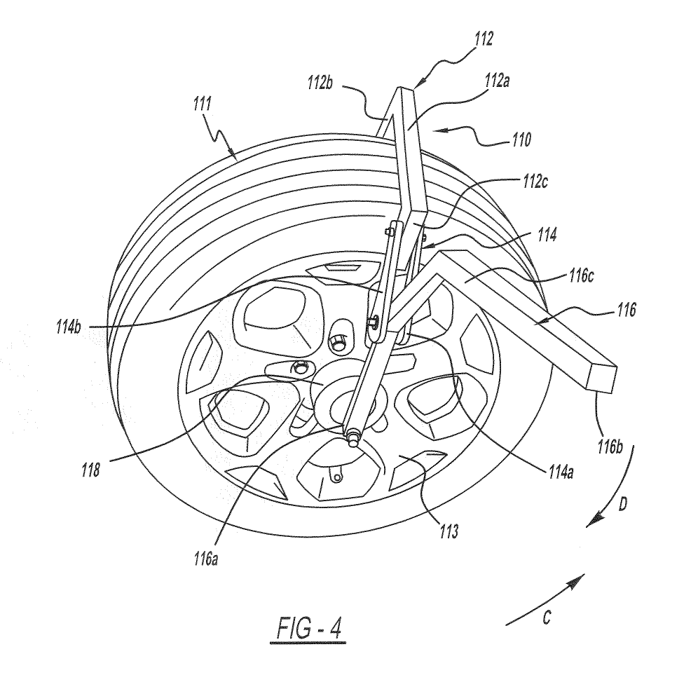

FIG. 4 shows a wheel ornament installation tool 100 in accordance with a second embodiment of the present invention. Tool 100 is shown engaged with a vehicle wheel 111 during application of a wheel ornament 113 to the wheel.

In the embodiment shown in FIG. 4, the supporting portion of the tool includes a first portion 112 for engaging wheel 111 during application of the wheel ornament to the wheel. First portion 112 has a base 112a and a pair of arms 112b, 112c extending from base 112a. Base 112a and arms 112b, 112c combine to define a cavity for receiving a portion of wheel 111 therein. Arms 112b, 112c are spaced apart so as to provide a slight clearance fit for wheel 111 when the wheel is inserted into the cavity. When wheel 111 is inserted into the first portion cavity, mounting of first portion 112 on wheel 111 provides a base for anchoring tool 100 while a user applies a force for attaching the wheel ornament to the wheel rim. First portion 112 may be formed as a single piece, for example by bending a piece of bar stock or tubing. Alternatively, arms 112b, 112c may be welded or otherwise suitably attached to base 112a to form the first portion.

In the embodiment shown in FIG. 4, first portion 112 is configured to engage wheel 111 during application of the wheel ornament to the wheel rim. However, first portion 112 may alternatively be configured to engage another portion of the vehicle (for example, a portion of the vehicle body, chassis, or frame). The first portion 112 may also be configured to engage a stationary object to support the rotatable portion during application of the force against the wheel ornament. This enables the supporting portion of the tool to serve as an anchor or base for the rotatable portion of the tool.

In an alternative embodiment, first portion base 112a is formed from two or more parts configured so as to telescope, enabling the length of the first portion 112 to be adjusted according to the width of a wheel to which the wheel ornament is to be applied.

First portion 112 may be formed from steel or any other material suitable for the uses of the first portion as described herein.

Referring again to FIG. 4, a second portion 114 is rotatably coupled both to first portion 112 and to a third portion 116 (described below). In the embodiment shown in FIG. 4, the rotatable portion of the tool includes a second portion rotatably coupled to the first portion 112 and a third portion 116 rotatably coupled to the second portion. Second portion 114 is formed from a pair of opposed plates 114a, 114b attached to opposite sides of arm 112c of first portion 112. However, second portion 114 may have any other structure suitable for the purposes described herein. Second portion 114 connects third portion 116 (which is effectively a lever through which a user applies a force needed to attach the wheel ornament to the wheel rim) to first portion 112, so that the first portion can serve as a secure base for operation of the third portion. Second portion 114 may be rotatably coupled to the first and third portions using any suitable mechanism, for example, bolts as shown in FIG. 4. Elements of second portion 114 may be formed from steel or any other material suitable for the uses of the first portion as described herein.

Referring again to FIG. 4, third portion 116 is rotatably coupled to second portion 114. In the embodiment shown in FIG. 4, third portion includes a first end 116a through which the wheel ornament attachment force is applied directly to the wheel ornament, a second end 116b which is manipulated by a user to apply the attachment force, and an intermediate portion 116c extending between ends 116a and 116b. Second portion 114 is rotatably connected to third portion 116 along intermediate portion 116c. The connection between second portion 114 and third portion 116 serves as a fulcrum for the third portion during application of the wheel ornament attachment force.

First end 116a may include a bearing portion 118 which contacts the wheel ornament and forces it onto the wheel. Bearing portion 118 may be configured to hold the wheel ornament prior to application of the ornament to the wheel. Alternatively, the wheel ornament may be seated on the wheel rim prior to bearing portion engaging the ornament to snap the ornament into place on the wheel. Bearing portion 118 may be formed from steel or any other material suitable for the uses of the bearing portion as described herein. Bearing portion 118 may be fabricated so as to have a surface finish smooth enough to prevent abrasion or other surface damage to the wheel ornament during application of the ornament to the wheel rim. In a particular embodiment, to prevent damage to the surface of the wheel ornament, bearing portion 118 is formed from a material (for example, a polymer material) having the strength and rigidity to transmit the applied assembly force to the wheel ornament without fracturing. Third portion 116 may be formed from steel or any other material suitable for the uses of the second portion as described herein.

Operation of tool 110 to attach a wheel ornament to wheel 111 will now be discussed with reference to FIG. 4.

First portion 112 is positioned over wheel 111 to mount the first portion on the wheel. This braces the tool against the vehicle for application of the ornament seating force by a user. Third portion 116 is then rotated about second portion 114 in the direction of arrow C, to enable pre-assembly positioning of the wheel ornament. The wheel ornament is then positioned on the wheel 111 or onto bearing portion 118. The bearing portion 118 can be configured with wheel ornament retention features suitable for holding the ornament thereon during attachment of the ornament to the wheel.

Next, third portion 116 is rotated by a user in the direction indicated by arrow D to apply the ornament to the wheel rim (or to apply a force to an ornament already positioned on the wheel rim). The user continues to apply force proximate second end 16b of third portion 116 until the resistance of the wheel ornament retention features engaging the wheel rim is overcome and the wheel ornament snaps into place. During this process first portion 112 braces the tool 110 against wheel 111 (or against another suitable portion of the vehicle).

It is noted that, in embodiments where the lengths of (or the locations of connections between) pertinent portions of the tools 10, 110 are not adjustable, the elements of the tools 10, 110 are dimensioned such that the portion of the respective tool through which force is applied to the wheel ornament is in substantial alignment with the area of the wheel ornament on which the force is to be applied, when the tool abuts or is mounted to the wheel (or other portion of the vehicle) as described herein.

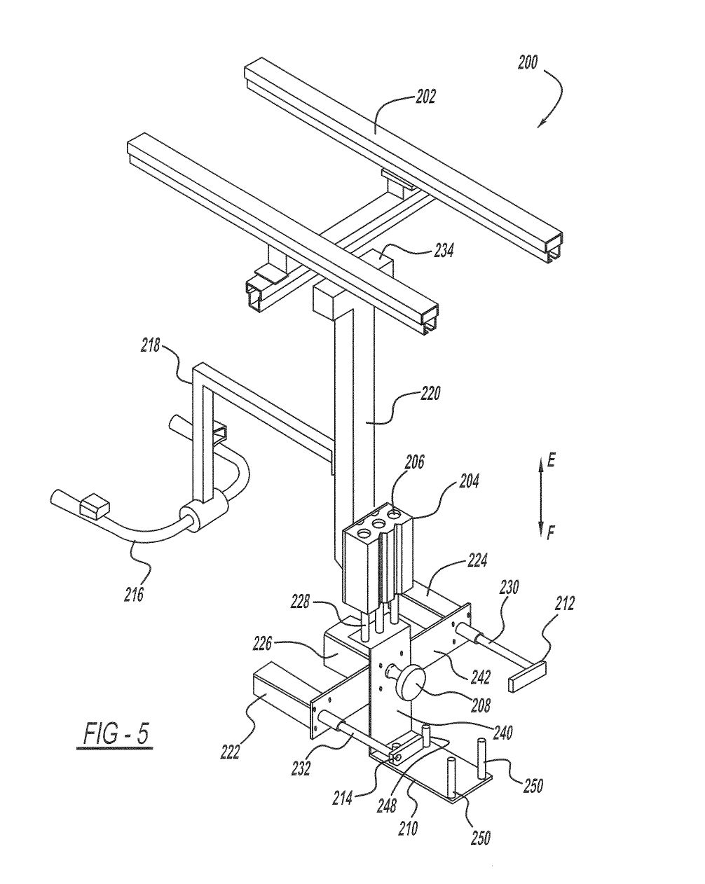

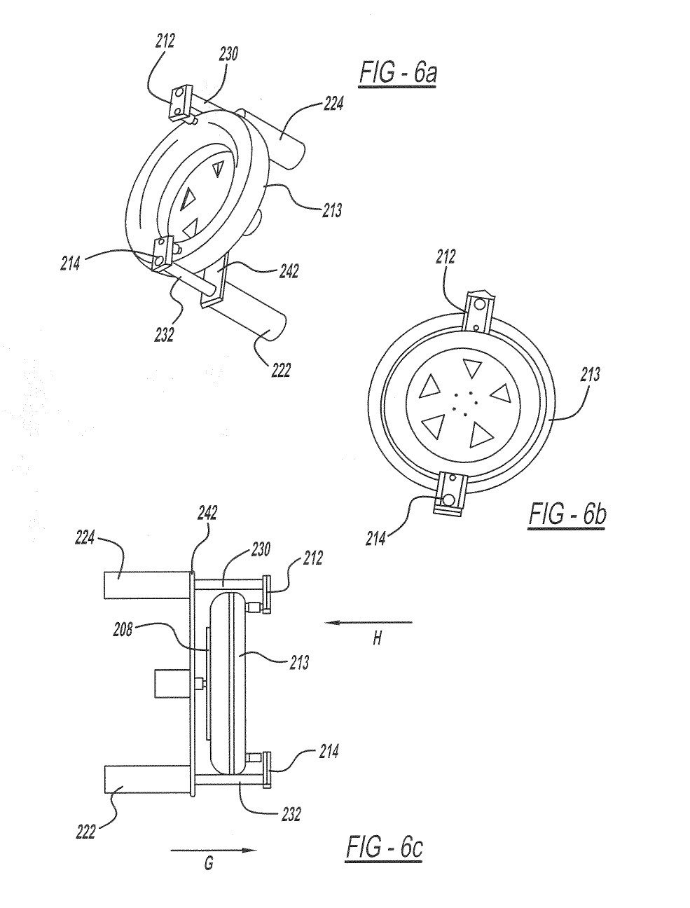

Referring now to FIGS. 5 and 6a-6c, in another embodiment, tool 200 is suspended from a user-positionable mounting or frame 202 in, for example, an assembly plant. Tool 200 includes a first portion 220 attached to frame 202, and a first actuator 204 attached to first portion 220.

First and second mounting plates 240 and 242 are coupled to each other and to first actuator 204. A second actuator 226 is also operatively coupled to first and second mounting plates 240 and 242 and to first actuator 204 so as to enable powered, controlled motion of the plates 240, 242 and second actuator 226 by the first actuator 204 in the vertical directions indicated by arrows E and F. First and second actuators 204 and 226 may be pneumatic, hydraulic, or any other type of actuator depending on the requirements of a particular application. A plunger of second actuator 226 may include a bearing member 208 operatively coupled thereto for contacting the wheel ornament to apply an attachment force to the wheel ornament. The bearing member 208 may include retention features formed thereon for holding the wheel ornament prior to attachment, as in the previously discussed embodiments.

At least one resiliently extendible gripping member is provided to aid in positioning and securing the ornament on the tool prior to attachment of the ornament to the wheel. In the embodiment shown in FIG. 5, a pair of gripping members 212, 214 extends from opposite ends of plate 242. Extendible gripping members 212, 214 apply a force on the wheel ornament in the direction indicated by arrow H in FIG. 6c, thereby biasing the wheel ornament against bearing member 208 prior to application of the wheel ornament to the wheel. Gripping members 212, 214 are housed in respective housings 222 and 224 attached to plate 242, and may be spring-loaded or pneumatically or hydraulically actuated depending on the requirements of a particular application. FIGS. 6a-6c show views of the wheel ornament 213 secured between bearing member 208 and gripping members 212, 214 prior to attachment of the ornament to the wheel.

A wheel positioning portion 210 (FIG. 5) extends from plate 240 and has mounted thereon two spaced-apart pairs of bolts or studs 248, 250. Pair 248 is spaced apart from pair 250 such that a tire or wheel rim (not shown) to which the ornament is to be attached will fit between the pairs of studs, to aid in positioning the tool with respect to the wheel prior to attachment of the ornament. An arm 218 extends from first portion 220, and a handle 216 is attached to arm 218 for user manipulation and positioning of the tool 200.

Any or all of the actuators used to position, secure, and/or otherwise control tool 200 may be controlled using controls mounted on handle 216 or at any other desired location. The system shown in FIG. 5 can be configured to operate using pneumatic actuators, hydraulic actuators, or any desired mix of hydraulic and pneumatic actuators, enabling the magnitude and speed of application of the applied attachment forces to be controlled as desired.

In operation, ornament 213 is positioned and secured between gripping members 212, 214 and bearing member 208. The vehicle (not shown) is suspended above a floor or other working surface to provide a clearance between the wheel and the working surface. A user positions tool 200 and/or controls first actuator 204 so that the wheel resides between studs 248 and 250 and so that the wheel ornament is in position for attachment to the wheel. The user then controls second actuator 226 so that bearing member 208 is forced in the direction indicated by arrow G in FIG. 6c, thereby pressing the wheel ornament 213 onto the wheel.

It will be understood that the foregoing descriptions of embodiments of the present invention are for illustrative purposes only. As such, the various structural and operational features disclosed herein are susceptible to a number of modifications commensurate with the abilities of one of ordinary skill in the art, none of which departs from the scope of the present invention as defined in the appended claims.

What is claimed is:

1. A wheel ornament installation tool comprising:
a supporting portion; and
a rotatable portion rotatably coupled to the supporting portion and configured to apply a force against a wheel ornament during rotation of the rotatable portion,
wherein the supporting portion is configured to engage a stationary object to support the rotatable portion during application of the force against the wheel ornament.

2. The tool of claim 1 wherein the supporting portion comprises a first portion and a second portion operatively coupled to the first portion,
and wherein the rotatable portion comprises a third portion rotatably coupled to the second portion and a fourth portion operatively coupled to the third portion for applying the force to the wheel ornament during rotation of the third portion.

3. The tool of claim 1 wherein the stationary object is a portion of a vehicle

4. The tool of claim 3 wherein the portion of the vehicle engaged by the supporting portion is a wheel to which the wheel ornament is to be attached.

5. The tool of claim 2 wherein the first portion is rotatable and securable with respect to the second portion so as to extend from the second portion in a predetermined direction

6. The tool of claim 2 wherein the first portion is adjustably positionable and securable along a length of the second portion.

7. The tool of claim 2 wherein the second portion is configured so as to have an adjustable length.

8. The tool of claim 1 wherein the rotatable portion includes at least one wheel ornament retention feature for holding a wheel ornament to the rotatable portion prior to application of the force to the wheel ornament.

9. The tool of claim 1 wherein the rotatable portion includes a cushion for contacting the wheel ornament during application of the force to the wheel ornament.

10. The tool of claim 2 wherein the fourth portion is configured so as to be adjustably positionable and securable along a length of the third portion.

11. The tool of claim 1 wherein the supporting portion comprises a first portion, and wherein the rotatable portion comprises a second portion rotatably coupled to the first portion and a third portion rotatably coupled to the second portion.

12. The tool of claim 11 wherein the first portion comprises a base and a pair of arms extending from the base to form a cavity therebetween configured for receiving a vehicle wheel therein.

13. The tool of claim 11 wherein the third portion includes a first end through which a force is applied to the wheel ornament, and a second end manipulable by a user to produce a rotation of the third portion with respect to the first portion

14. The tool of claim 11 wherein the first portion is configured so as to have an adjustable length.

15. The tool of claim 13 wherein the third portion first end includes at least one wheel ornament retention feature for holding a wheel ornament to the third portion prior to application of the force to the wheel ornament.

16. A wheel ornament installation tool comprising:
a first actuator; and
a second actuator for applying a force to a wheel ornament,
wherein the second actuator is operatively coupled to the first actuator
so as to enable vertical positioning of the second actuator by the first actuator.

17. The tool of claim 16 wherein the second actuator has a plunger and a bearing member operatively coupled to the plunger for contacting the wheel ornament to apply an attachment force to the wheel ornament

18. The tool of claim 17 further comprising at least one gripping member configured for biasing the wheel ornament against the bearing member.

19. The tool of claim 16 further comprising a wheel positioning portion 210 operatively coupled to the second actuator to aid in positioning the tool with respect to a wheel prior to installation of the ornament on the wheel.

20. The tool of claim 16 further comprising a first portion operatively coupled to the first actuator, the first portion being configured for attachment to a user-positionable frame, and an arm extending from the first portion for user manipulation and positioning of the tool.
